(19) United States
(12) Patent Application Publication
(10) Pub. No.: US 2025/0238666 A1
(43) Pub. Date: Jul. 24, 2025

(54) ELECTRONIC DEVICE AND CONTROL METHOD THEREOF

(71) Applicant: SAMSUNG ELECTRONICS CO., LTD., Suwon-si (KR)

(72) Inventors: Dongkyu KIM, Suwon-si (KR); Woojung Kim, Suwon-si (KR)

(73) Assignee: SAMSUNG ELECTRONICS CO., LTD., Suwon-si (KR)

(21) Appl. No.: 19/172,127

(22) Filed: Apr. 7, 2025

Related U.S. Application Data
(63) Continuation of application No. PCT/KR2023/016379, filed on Oct. 20, 2023.

(30) Foreign Application Priority Data
Nov. 28, 2022 (KR) 10-2022-0161707

(51) Int. Cl. G06N 3/0495

(52) U.S. Cl. CPC G06N 3/0495

(57) ABSTRACT

A control method of an electronic device includes obtaining information about a parameter of a neural network model, identifying a maximum value and a minimum value of the parameter of the neural network model based on the obtained information about the parameter of the neural network model, obtaining a quantization scale in the form of a power of two by adjusting the maximum value and the minimum value of the parameter of the neural network model, and quantizing the parameter of the neural network model based on the quantization scale in the form of a power of two.

### CROSS-REFERENCE TO RELATED APPLICATIONS

This application is a continuation of International Application No. PCT/KR2023/016379, filed on Oct. 20, 2023, in the Korean Intellectual Property Receiving Office, which is based on and claims priority to Korean Patent Application No. 10-2022-0161707, filed on Nov. 28, 2022, in the Korean Intellectual Property Office, the disclosures of which are incorporated by reference herein in their entireties.

### BACKGROUND

### 1. Field

The disclosure relates to an electronic device and a control method thereof, and more particularly, to an electronic device that quantizes a parameter of a neural network model by using a quantization scale, and a control method thereof.

### 2. Description of Related Art

Recently, artificial intelligence systems are being used in various fields. An artificial intelligence system is a system where a machine learns, determines, and becomes smarter by itself, unlike conventional rule-based smart systems. An artificial intelligence system shows a more improved recognition rate as it is used more, and becomes capable of understanding user preference more correctly. For this reason, conventional rule-based smart systems are gradually being replaced by deep learning-based artificial intelligence systems.

An artificial intelligence system performs a complex operation by using a neural network model. In order for an electronic device to perform a complex operation, a lot of parameters are included in a neural network model. In particular, a parameter included in a neural network model is expressed as a real number of predetermined bits (e.g., 32 bits), and there is a problem that, as the size of the neural network model increases, the use amount of the memory increases, and the resource or the time for a neural network operation increases.

For resolving such a problem, research for a technology for quantizing parameters of a neural network model is active. Quantization is a technology of converting a weight in a form of a floating point into a form of an integer, and in this case, there is a problem that, if the bit number of the integer is reduced, the operation speed and the use amount of the memory decrease greatly, but the precision is reduced greatly. In particular, an operation of multiplying a quantization scale is an operation that is slower compared to other operations (e.g., an addition, etc.), and there is a problem that the processing speed becomes slow.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

Additional aspects will be set forth in part in the description which follows and, in part, will be apparent from the description, or may be learned by practice of the presented embodiments.

According to an aspect of the disclosure, a control method of an electronic device may include obtaining information about a parameter of a neural network model, identifying a maximum value and a minimum value of the parameter of the neural network model based on the obtained information about the parameter of the neural network model, obtaining a quantization scale in the form of a power of two by adjusting the maximum value and the minimum value of the parameter of the neural network model, and quantizing the parameter of the neural network model based on the quantization scale in the form of a power of two.

The obtaining the quantization scale may include adjusting the maximum value and the minimum value of the parameter of the neural network model to satisfy

$$b - a = C \cdot {2}^{\hat{k}} , C = \frac{{2}^{n} - 1}{{2}^{n}} .$$

where b is the maximum value, a is the minimum value, n is a bit number of quantization, and \hat{k} is a random integer.

The obtaining the quantization scale may include, based on the electronic device performing symmetric quantization, adjusting the maximum value and the minimum value of the parameter of the neural network model to satisfy \tilde{b}=2^{nearest_int(log}^{₂}^{b/C)}, ã=−2^{nearest_int(log}^{₂}^{b/C)}, where \tilde{b} is a power of two adjacent to b, and ã is a power of two adjacent to a.

Based on the electronic device performing symmetric quantization, the quantization scale s may be obtained based on

$$s = \frac{{2}^{n - 1}}{{2}^{nearest . int} ( {log}_{2} b / c )} .$$

The obtaining the quantization scale may include, based on the electronic device performing asymmetric quantization, adjusting the maximum value b and the minimum value a of the parameter of the neural network model to satisfy \tilde{d}=2^{nearest_int(log}^{₂}^{d)}, d=(b−a)/C, where \tilde{d} is a power of two adjacent to d.

Based on the electronic device performing asymmetric quantization, the quantization scale s may be obtained based on

$$s = \frac{{2}^{n}}{{2}^{nearest . int} ( {log}_{2} ( b - a ) / c )} .$$

The obtaining the information about the parameter of the neural network model may include obtaining information about a quantization option including information about bit numbers of quantization for each layer and information about whether quantization scales for each layer are a power of two, and the quantizing may include quantizing the parameter of the neural network model based on the information about the quantization option.

The parameter of the neural network model may include a weight and an activation, and the quantizing may include performing quantization for each channel based on the weight, and performing quantization for each layer based on the activation.

According to an aspect of the disclosure, an electronic device may include memory storing instructions, and at least one processor, where the instructions, when executed by the at least one processor, may cause the electronic device to obtain information about a parameter of a neural network model, identify a maximum value and a minimum value of the parameter of the neural network model based on the obtained information about the parameter of the neural network model, obtain a quantization scale in the form of a power of two by adjusting the maximum value and the minimum value of the parameter of the neural network model, and quantize the parameter of the neural network model based on the quantization scale in the form of a power of two.

The instructions, when executed by the at least one processor, may further cause the electronic device to adjust the maximum value and the minimum value of the parameter of the neural network model to satisfy

$$b - a = C \cdot {2}^{\hat{k}} , C = \frac{{2}^{n} - 1}{{2}^{n}} ,$$

where b is the maximum value, a is the minimum value, n is a bit number of quantization, and \hat{k} is a random integer.

The instructions, when executed by the at least one processor, may further cause the electronic device to, based on the electronic device performing symmetric quantization, adjust the maximum value and the minimum value of the parameter of the neural network model to satisfy \tilde{b}=2^{nearest_int(log}^{₂}^{b/C)}, ã=−2^{nearest_int(log}^{₂}^{b/C)}, where \tilde{b} is a power of two adjacent to b, and ã is a power of two adjacent to a.

Based on the electronic device performing symmetric quantization, the quantization scale s may be obtained based on

$$s = \frac{{2}^{n - 1}}{{2}^{nearest . int} ( {log}_{2} b / c )} .$$

The instructions, when executed by the at least one processor, may further cause the electronic device to, based on the electronic device performing asymmetric quantization, adjust the maximum value b and the minimum value a of the parameter of the neural network model to satisfy \tilde{d}=2^{nearest_int(log}^{₂}^{d)}, d=(b−a)/C, where \tilde{d} is a power of two adjacent to d.

Based on the electronic device performing asymmetric quantization, the quantization scale s may be obtained based on

$$s = \frac{{2}^{n}}{{2}^{nearest . int} ( {log}_{2} ( b - a ) / c )} .$$

The instructions, when executed by the at least one processor, may further cause the electronic device to obtain information about a quantization option including information about bit numbers of quantization for each layer and information about whether quantization scales for each layer are a power of two, and quantize the parameter of the neural network model based on the information about the quantization option.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to one or more embodiments of the disclosure;

FIG. 2 is a block diagram illustrating a configuration for an electronic device to perform quantization according to one or more embodiments of the disclosure;

FIG. 3A is a diagram illustrating a method of performing symmetric quantization according to one or more embodiments of the disclosure;

FIG. 3B is a diagram illustrating a method of performing asymmetric quantization according to one or more embodiments of the disclosure;

FIG. 4A is a diagram illustrating a method of quantizing a parameter by a quantization-aware training method according to one or more embodiments of the disclosure;

FIG. 4B is a diagram illustrating a method of quantizing a parameter by a post-training quantization method according to one or more embodiments of the disclosure; and

FIG. 5 is a flowchart illustrating a control method of an electronic device that quantizes a parameter of a neural network model according to one or more embodiments of the disclosure.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

Also, in describing the disclosure, in case it is determined that detailed explanation of related known functions or features may unnecessarily confuse the gist of the disclosure, the detailed explanation will be omitted.

In addition, the embodiments described below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Also, the terms used in the disclosure are used only to explain specific embodiments, and are not intended to limit the scope of the disclosure. Further, singular expressions include plural expressions, unless defined differently in the context.

In addition, in the disclosure, expressions such as “have,” “may have,” “include,” and “may include” denote the existence of such characteristics (e.g., elements such as numbers, functions, operations, and components), and do not exclude the existence of additional characteristics.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

In addition, the expressions “first,” “second,” and the like used in the disclosure may describe various elements regardless of any order and/or degree of importance. Also, such expressions are used only to distinguish one element from another element, and are not intended to limit the elements.

The description in the disclosure that one element (e.g., a first element) is “(operatively or communicatively) coupled with/to” or “connected to” another element (e.g., a second element) should be interpreted to include both the case where the one element is directly coupled to the another element, and the case where the one element is coupled to the another element through still another element (e.g., a third element).

In contrast, the description that one element (e.g., a first element) is “directly coupled” or “directly connected” to another element (e.g., a second element) may be interpreted to mean that still another element (e.g., a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. The term “configured to” may not necessarily mean that a device is “specifically designed to” in terms of hardware.

Instead, under some circumstances, the expression “a device configured to” may mean that the device “is capable of” performing an operation together with another device or component. For example, the phrase “a processor configured to perform A, B, and C” may mean a dedicated processor (e.g., an embedded processor) for performing the corresponding operations, or a generic-purpose processor (e.g., a CPU or an application processor) that may perform the corresponding operations by executing one or more software programs stored in a memory device.

Further, in the embodiments of the disclosure, ‘a module’ or ‘a unit’ may perform at least one function or operation, and may be implemented as hardware or software, or as a combination of hardware and software. Also, a plurality of ‘modules’ or ‘units’ may be integrated into at least one module and implemented as at least one processor, excluding ‘a module’ or ‘a unit’ that needs to be implemented as specific hardware.

Various elements and areas in the drawings were illustrated schematically. Accordingly, the technical idea of the disclosure is not limited by the relative sizes or intervals illustrated in the accompanying drawings.

Hereinafter, embodiments according to the disclosure will be described in detail with reference to the accompanying drawings, such that those having ordinary skill in the art to which the disclosure belongs may easily carry out the embodiments.

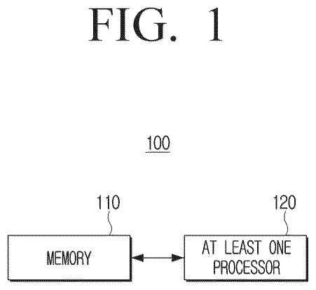

FIG. 1 is a block diagram illustrating a configuration of an electronic device according to one or more embodiments of the disclosure. As illustrated in FIG. 1, the electronic device 100 may include memory 110 and at least one processor 120. The electronic device 100 may be a server. However, this is merely an example, and the electronic device 100 may be a user terminal. The components of the electronic device 100 are not limited to the components illustrated in FIG. 1.

The memory 110 may store an operating system (OS) for controlling the overall operations of the components of the electronic device 100 and at least one instruction or data related to the components of the electronic device 100. Also, the memory 110 may store data that is necessary for a module for controlling the operations of the electronic device 100 to perform various kinds of operations.

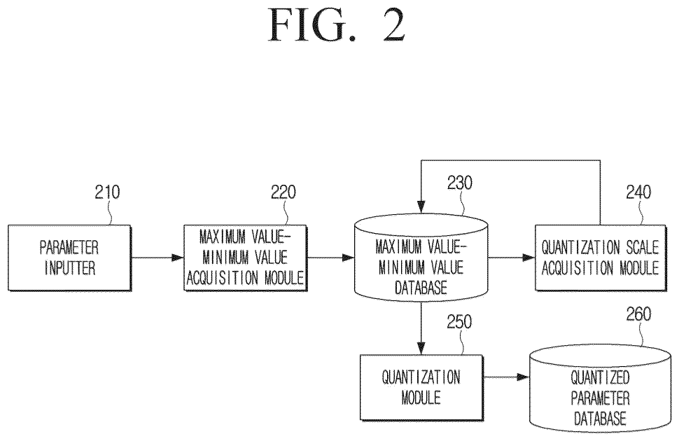

The components for controlling an operation of the electronic device 100 of quantizing a parameter of a neural network model may include a parameter inputter 210, a maximum value-minimum value acquisition module 220, a maximum value-minimum value database 230, a quantization scale acquisition module 240, a quantization module 250, and a quantized parameter database 260, as illustrated in FIG. 2.

The memory 110 may include non-volatile memory that may maintain the stored information even if power supply is stopped, and volatile memory that that needs constant power supply for maintaining the stored information. The components for controlling the operation of quantizing a parameter of a neural network model may be stored in the non-volatile memory.

Also, the memory 110 may include information about a neural network model for performing a specific function (e.g., information about a parameter), training data, and information about a quantization option, etc.

The at least one processor 120 controls the overall operations of the electronic device 100. Specifically, the at least one processor 120 may be connected with the components of the electronic device 100 including the memory 110, and control the overall operations of the electronic device 100 by executing the at least one instruction stored in the memory 110 as described above.

If a quantization task for the parameter of the neural network model is performed, the at least one processor 120 may load the data for the components stored in the non-volatile memory (the parameter inputter 210, the maximum value-minimum value acquisition module 220, the quantization scale acquisition module 240, etc.) to perform various kinds of operations on the volatile memory. Loading may refer to an operation of calling in data stored in the non-volatile memory to the volatile memory and storing the data, so that the at least one processor 120 may access the data.

In particular, the at least one processor 120 obtains information about the parameter of the neural network model. Then, the at least one processor 120 identifies a maximum value and a minimum value of the parameter included in the neural network model based on the obtained information about the parameter. Then, the at least one processor 120 obtains a quantization scale in the form of a power of two by adjusting the maximum value and the minimum value of the parameter. Then, the at least one processor 120 quantizes the parameter of the neural network model based on the quantization scale in the form of a power of two.

Specifically, as described above, in a process wherein the electronic device quantizes the parameter, the parameter of the neural network model should be multiplied by a quantization scale. An operation of multiplying a quantization scale is an operation that is slower compared to other operations (e.g., an addition, etc.), and there is a problem that the processing speed becomes slow. However, in a quantization process, if the quantization scale is in the form of a power of two, the calculation speed may be increased by using a fast operation which is bit shift instead of a multiplication operation.

For example, if 100101₍₂₎ is multiplied by 23, the outcome may become 100101000₍₂₎ through bit left shift, and if 100101.1101₍₂₎ is multiplied by 2⁻², the outcome may become 1001.011101₍₂₎ through bit right shift.

Accordingly, in case the quantization scale is adjusted to the form of a power of two in a quantization process, there is an effect that the quantization process becomes faster.

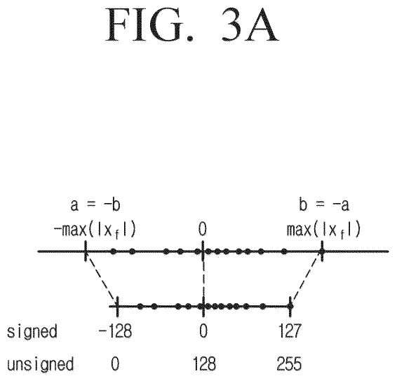

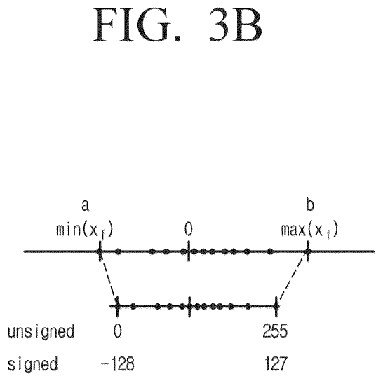

By this, the at least one processor 120 may adjust the maximum value and the minimum value of the parameter of the neural network model such that the quantization scale becomes the form of a power of two. Explanation in this regard will be described with reference to FIG. 2 to FIG. 3B.

Also, the at least one processor 120 may obtain information about a quantization option including information about bit numbers of quantization for each layer and information about whether quantization scales for each layer are a power of two. Then, the at least one processor 120 may quantize the parameter of the neural network model based on the information about the quantization option.

Also, the parameter may include a weight and activation. Further, the at least one processor 120 may perform quantization for each channel based on the weight and perform quantization for each layer based on the activation.

Hereinafter, the disclosure will be described in more detail with reference to FIG. 2.

FIG. 2 is a block diagram illustrating a configuration for an electronic device to perform quantization according to one or more embodiments of the disclosure. FIG. 3A is a diagram illustrating a method of performing symmetric quantization according to one or more embodiments of the disclosure. FIG. 3B is a diagram illustrating a method of performing asymmetric quantization according to one or more embodiments of the disclosure.

Specifically, for quantizing the parameter of the neural network model, the electronic device 100 may include the parameter inputter 210, the maximum value-minimum value acquisition module 220, the maximum value-minimum value database 230, the quantization scale acquisition module 240, the quantization module 250, and the quantized parameter database 260, as illustrated in FIG. 2.

The parameter inputter 210 may obtain information about the parameter of the neural network model. The parameter of the neural network model may include a weight and activation. Also, the parameter inputter 210 may obtain information about the quantization option. The information about the quantization option may include information about bit numbers of quantization for each layer and information about whether quantization scales for each layer are a power of two.

The maximum value-minimum value acquisition module 220 may identify the maximum value and the minimum value of the parameter based on the information about the parameter obtained through the parameter inputter 210. The maximum value-minimum value acquisition module 220 may identify the maximum values and the minimum values for each channel regarding the weight. Also, the maximum value-minimum value acquisition module 220 may identify the maximum values and the minimum values for each layer regarding the activation.

The maximum value-minimum value database 230 may store information about the maximum values and the minimum values obtained from the maximum value-minimum value acquisition module 220. Regarding the weight, the maximum value-minimum value database 230 may store the maximum values and the minimum values for each channel, and regarding the activation, may store the maximum values and the minimum values for each layer.

The quantization scale acquisition module 240 may adjust the maximum value and the minimum value such that the quantization scale becomes a power of two. The quantization scale is a value multiplied to a parameter value for quantizing the parameter value as an integer.

Specifically, the electronic device 100 may perform the quantization process by a method as in Equation (1).

$$q = round ( \frac{r - a}{s} ) = round ( \frac{r}{s} + z ) , where \qquad ( 1 )$$

$$s = \frac{b - a}{{2}^{n} - 1} and$$

$$z = round ( - \frac{a}{s} )$$

q may be a quantized integer value, n may be a bit number, r may be a parameter value (a weight value or an activation value) to be quantized, a may be the minimum value among parameters, b may be the maximum value among parameters, s may be a quantization scale, and z may be a zero-point.

In order that the quantization scale s may become a power of two (s=2^{k}), b−a may be expressed as in Equation (2).

$$b - a = \frac{{2}^{n} - 1}{{2}^{k}} = \frac{{2}^{n} - 1}{{2}^{n} {2}^{k - n}} = \frac{{2}^{n} - 1}{{2}^{n}} {2}^{\hat{k}} = C \cdot {2}^{\hat{k}} \qquad ( 2 )$$

That is, in order that the quantization scale may become a power of two, a condition as in Equation (3) should be satisfied.

$${2}^{\hat{k}} = ( b - a ) / C \qquad ( 3 )$$

In particular, in case the electronic device 100 performs symmetric quantization, it may become b=−a as illustrated in FIG. 3A. That is, in the case of performing symmetric quantization, the maximum value and the minimum value may be located in the same distance based on the zero-point.

Accordingly, (b−a)/C may be substituted to 2*b/C. Also, the electronic device 100 may adjust the maximum value b to a power of two \tilde{b} adjacent to the maximum value b through the Equation (4).

$$\tilde{b} = {2}^{nearest \_ int ( {log}_{2} b / C )} \qquad ( 4 )$$

Also, the electronic device 100 may adjust the minimum value a to a power of two ã adjacent to the minimum value a through Equation (5).

$$\tilde{a} = - {2}^{nearest \_ int ( {log}_{2} b / C )} \qquad ( 5 )$$

In the case of adjusting the maximum value and the minimum value as above, the electronic device 100 may obtain the quantization scale s as in Equation (6).

$$s = \frac{{2}^{n - 1}}{{2}^{nearest \_ int ( {log}_{2} b / C )}} \qquad ( 6 )$$

The electronic device 100 may store information about the obtained quantization scale s and information about the adjusted maximum value and minimum value in the maximum value-minimum value database 230.

Also, in case the electronic device 100 performs asymmetric quantization as illustrated in FIG. 3B, the electronic device 100 may adjust d=(b−a)/C to an adjacent power of two.

That is, the electronic device 100 may adjust the maximum value b and the minimum value a of the parameter to satisfy Equation (7).

$$\tilde{d} = {2}^{nearest \_ int ( {log}_{2} d )} \qquad ( 7 )$$

\tilde{d} is a power of two adjacent to d.

Then, based on \tilde{d}, the electronic device 100 may adjust the maximum value b and the minimum value a to satisfy Equation (8).

$$\tilde{b} = b \tilde{\frac{d}{d}} , \tilde{a} = a \tilde{\frac{d}{d}} \qquad ( 8 )$$

In the case of adjusting the maximum value and the minimum value as above, the electronic device 100 may obtain the quantization scale s as in Equation (9).

$$s = \frac{{2}^{n}}{{2}^{nearest \_ int ( {log}_{2} ( b - a ) / C )}} \qquad ( 9 )$$

The electronic device 100 may store information about the obtained quantization scale s and information about the adjusted maximum value and minimum value in the maximum value-minimum value database 230.

In particular, when the electronic device 100 obtains a quantization scale in the form of a power of two, an operation process regarding nearest_int is needed.

According to one or more embodiments, the electronic device 100 may perform an operation by fixing one of rounding off, rounding up, or rounding down for each layer.

According to one or more embodiments, the electronic device 100 may perform an operation by selecting one of rounding up or rounding down for each layer through a process as in Equation (10).

$$s = {arg min}_{s ∈ \{ {s}_{c eil} , {s}_{floor} \}} {‖ X - s ( round ( \frac{X}{s} + z ) - z ) ‖}_{2} \qquad ( 10 )$$

The type of X is one of a weight (symmetric, z=0) or activation (asymmetric).

In case the electronic device 100 performs symmetric quantization, the electronic device 100 may obtain a quantization scale by selecting rounding up or rounding down for each layer through Equation (11).

$${s}_{floor} = \frac{{2}^{n - 1}}{{2}^{floor ( {log}_{2} b / C )}} , {s}_{c eil} = \frac{{2}^{n - 1}}{{2}^{ce il ( {log}_{2} b / C )}} \qquad ( 11 )$$

Also, in case the electronic device 100 performs asymmetric quantization, the electronic device 100 may obtain a quantization scale by selecting rounding up or rounding down for each layer through Equation (12).

$${s}_{floor} = \frac{{2}^{n}}{{2}^{floor ( {log}_{2} ( b - a ) / C )}} , {s}_{ceil} = \frac{{2}^{n}}{{2}^{ceil ( {log}_{2} ( b - a ) / C )}} \qquad ( 12 )$$

The quantization module 250 may perform quantization based on the information about the maximum value and the minimum value stored in the maximum value-minimum value database. That is, the quantization module 250 may perform quantization through the quantization scale in the form of a power of two obtained through the quantization scale acquisition module 240.

The quantization module 250 may perform quantization for each channel regarding the weight, and perform quantization for each layer regarding the activation.

Also, the quantization module 250 may quantize the parameter of the neural network model based on the information about the quantization option obtained by the parameter inputter 210. That is, the quantization module 250 may quantize the parameter of the neural network model based on the information about the bit numbers of quantization for each layer and the information about whether the quantization scales for each layer are a power of two. For example, in case the bit number of quantization of the first layer is 4, and the bit number of quantization of the second layer is 5, the quantization module 250 may quantize the first layer as 4 bits, and quantize the second layer as 5 bits. Also, in case the quantization scale is in the form of a power of two only regarding the first to third layers among the plurality of layers, the quantization module 250 may perform quantization by using the quantization scale in the form of a power of two only regarding the first to third layers.

Then, the quantization module 250 may store the quantized parameter in the quantized parameter database 260.

Methods of quantization may be divided into a post-training quantization (referred to as “PTQ” hereinafter) method and a quantization-aware training (referred to as “QAT” hereinafter) method based on a time point of performing quantization. The PTQ method has an advantage that quantization is possible within a short time by using a small amount of training data. Also, the QAT method has an advantage that the precision of a model is higher compared to the PTQ method. The method of performing quantization by using a quantization scale in the form of a power of two according to one or more embodiments of the disclosure may be applied both to the PTQ method and the QAT method.

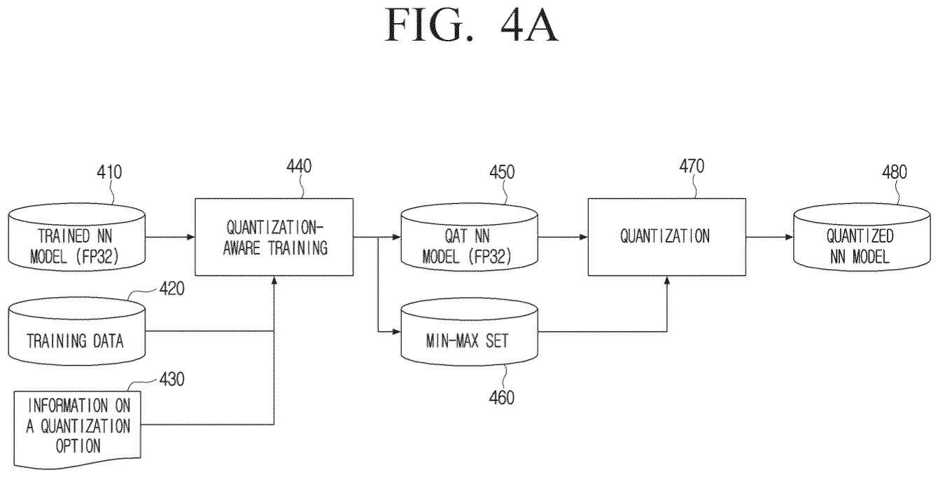

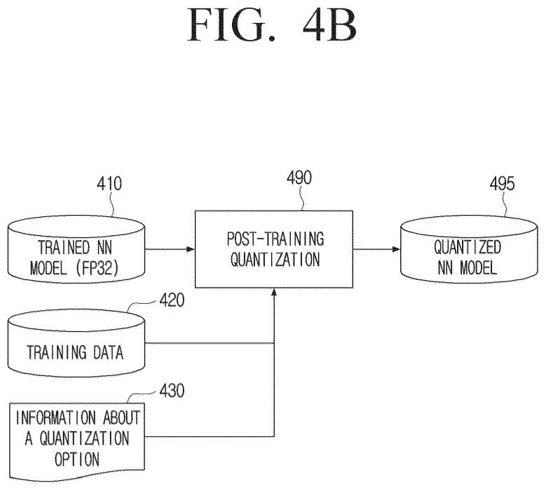

FIG. 4A is a diagram illustrating a method of quantizing a parameter by a quantization-aware training method according to one or more embodiments of the disclosure.

The electronic device 100 may obtain a trained neural network model 410, training data 420, and information about a quantization option 430. The trained neural network model 410 may be a neural network model that was trained in advance, which uses a parameter of a floating point value of 32 bits (an FP 32 network).

Then, the electronic device 100 may obtain a quantized QAT neural network model 450 and a maximum value-minimum value set 460 through a QAT process 440. That is, the electronic device 100 may train the neural network model by identifying an application location of the neural network model based on the information about the quantization option, inserting a quantization task into the application location, simulating a quantization noise, and fine-tuning the parameter of the neural network model. By this, the electronic device 100 may obtain the QAT neural network model 450. The QAT neural network model 450 may also be a neural network model that uses a parameter of a floating point value of 32 bits (an FP 32 network). Also, the maximum value-minimum value set 460 may store the maximum value and the minimum value of the parameter that were adjusted to have a quantization scale in the form of a power of two, as described above.

Then, the electronic device 100 may perform quantization 470 based on the QAT neural network model 450 and the maximum value-minimum value set 460, and obtain a quantized neural network model 480 based on the performing result. The quantized neural network model 480 may be a neural network model that was quantized for each layer based on the information about the quantization option.

FIG. 4B is a diagram illustrating a method of quantizing a parameter by a post-training quantization method according to one or more embodiments of the disclosure.

The electronic device 100 may obtain a trained neural network model 410, training data 420, and information about a quantization option 430. The trained neural network model 410 may be a neural network model that was trained in advance, which uses a floating point value of 32 bits (an FP 32 network).

The electronic device 100 may obtain a quantized neural network model 495 through performing a PTQ process 490 for the pre-trained neural network model. In the PTQ process 490, a quantization process may be performed through the quantization scale in the form of a power of two obtained by the method as explained in FIG. 2 to FIG. 3B. Also, the quantized neural network model 495 may be a neural network model that was quantized for each layer based on the information about the quantization option.

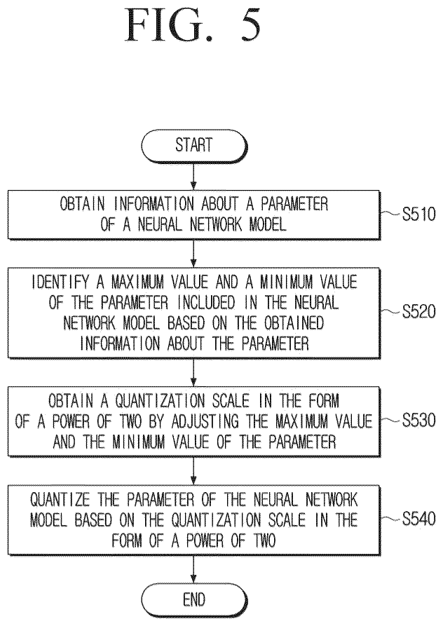

FIG. 5 is a flowchart illustrating a control method of an electronic device that quantizes a parameter of a neural network model according to one or more embodiments of the disclosure.

First, the electronic device 100 may obtain information about a parameter of a neural network model in operation S510. The information about the parameter may include information about a weight and activation. Also, the electronic device 100 may obtain information about a quantization option including not only the information about the parameter but also information about bit numbers of quantization for each layer and information about whether quantization scales for each layer are a power of two.

The electronic device 100 may identify a maximum value and a minimum value of the parameter included in the neural network model based on the obtained information about the parameter in operation S520. The electronic device 100 may identify the maximum values and the minimum values for each channel regarding the weight in the parameter, and identify the maximum values and the minimum values for each layer regarding the activation.

The electronic device 100 may obtain a quantization scale in the form of a power of two by adjusting the maximum value and the minimum value of the parameter in operation S530. Specifically, the electronic device 100 may obtain a quantization scale in the form of a power of two by adjusting the maximum value and the minimum value of the parameter by the method as explained in Equations (1) through (12).

The electronic device 100 may quantize the parameter of the neural network model based on the quantization scale in the form of a power of two in operation S540. The electronic device 100 may quantize the parameter of the neural network model based on the information about the quantization option. Also, the electronic device 100 may perform quantization for each channel regarding the weight and perform quantization for each layer regarding the activation.

As described above, by performing quantization by using a quantization scale in the form of a power of two, an effect that the processing speed becomes faster than in a conventional quantization process may be achieved.

Functions related to artificial intelligence according to the disclosure are operated through the processor and the memory of the electronic device 100.

The processor may include one or a plurality of processors. The one or plurality of processors may include at least one of a central processing unit (CPU), a graphic processing unit (GPU), or a neural processing unit (NPU), but the processors are not limited to the aforementioned examples of processors.

A CPU is a generic-purpose processor that may perform not only general operations but also artificial intelligence operations, and it may effectively execute a complex program through a multilayer cache structure. A CPU is advantageous for a serial processing method that enables a systemic linking between the previous calculation result and the next calculation result through sequential calculations. A generic-purpose processor is not limited to the aforementioned examples

A GPU is a processor for mass operations such as a floating point operation used for graphic processing, etc., and it may perform mass operations in parallel by massively integrating cores. In particular, a GPU may be advantageous for a parallel processing method such as a convolution operation, etc. compared to a CPU. Also, a GPU may be used as a co-processor for supplementing the function of a CPU. A processor for mass operations is not limited to the aforementioned examples.

An NPU is a processor specialized for an artificial intelligence operation using an artificial neural network, and it may implement each layer constituting an artificial neural network as hardware (e.g., silicon). The NPU is designed to be specialized according to the required specification of a company, and thus it has a lower degree of freedom compared to a CPU or a GPU, but it may effectively process an artificial intelligence operation required by the company. As a processor specialized for an artificial intelligence operation, an NPU may be implemented in various forms such as a tensor processing unit (TPU), an intelligence processing unit (IPU), a vision processing unit (VPU), etc. An artificial intelligence processor is not limited to the aforementioned examples.

Also, the one or plurality of processors may be implemented as a system on chip (SoC). In the SoC, the memory, and a network interface such as a bus for data communication between the processor and the memory, etc. may be further included other than the one or plurality of processors.

In case the plurality of processors are included in the system on chip (SoC) included in the electronic device, the electronic device may perform an operation related to artificial intelligence (e.g., an operation related to learning or inference of the artificial intelligence model) by using some processors among the plurality of processors. For example, the electronic device may perform an operation related to artificial intelligence by using at least one of a GPU, an NPU, a VPU, a TPU, or a hardware accelerator specified for artificial intelligence operations such as a convolution operation, a matrix product operation, etc. among the plurality of processors. However, this is merely an example, and the electronic device may process an operation related to artificial intelligence by using the generic-purpose processor such as a CPU, etc.

Also, the electronic device may perform operations regarding functions related to artificial intelligence by using a multicore (e.g., a dual core, a quad core, etc.) included in one processor. In particular, the electronic device may perform artificial intelligence operations such as a convolution operation, a matrix product operation, etc. by using the multicore included in the processor.

The one or plurality of processors perform control to process input data according to predefined operation rules or an artificial intelligence model stored in the memory. The predefined operation rules or the artificial intelligence model are characterized in that they are made through learning.

Being made through learning may indicate that predefined operation rules or an artificial intelligence model having desired characteristics are made by applying a learning algorithm to a plurality of training data. Such learning may be performed in a device itself where artificial intelligence is performed according to the disclosure, or through a separate server/system.

An artificial intelligence model may include a plurality of neural network layers. At least one layer has at least one weight value, and performs an operation of the layer through the operation result of the previous layer and at least one defined operation. As examples of a neural network, there are a convolutional neural network (CNN), a deep neural network (DNN), a recurrent neural network (RNN), a restricted Boltzmann Machine (RBM), a deep belief network (DBN), a bidirectional recurrent deep neural network (BRDNN), deep Q-networks, and a transformer, but the neural network in the disclosure is not limited to the aforementioned examples excluding specified cases.

A learning algorithm is a method of training a specific subject device (e.g., a robot) by using a plurality of training data and thereby making the specific subject device make a decision or make prediction by itself. As examples of learning algorithms, there are supervised learning, unsupervised learning, semi-supervised learning, or reinforcement learning, but learning algorithms in the disclosure are not limited to the aforementioned examples excluding specified cases.

Various embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

At least one of the devices, units, components, modules, units, or the like represented by a block or an equivalent indication in the above embodiments may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

Also, the method according to the various embodiments of the disclosure may be implemented as software including instructions stored in machine-readable storage media, which can be read by machines (e.g.: computers). The machines refer to devices that call instructions stored in a storage medium, and can operate according to the called instructions, and the devices may include an electronic device according to the aforementioned embodiments (e.g., a TV).

In case an instruction is executed by the processor, the processor may perform a function corresponding to the instruction by itself, or by using other components under its control. An instruction may include a code that is generated or executed by a compiler or an interpreter.

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. A control method of an electronic device, the method comprising:
obtaining information about a parameter of a neural network model;
identifying a maximum value and a minimum value of the parameter of the neural network model based on the obtained information about the parameter of the neural network model;
obtaining a quantization scale in the form of a power of two by adjusting the maximum value and the minimum value of the parameter of the neural network model; and
quantizing the parameter of the neural network model based on the quantization scale in the form of a power of two.

2. The control method of claim 1, wherein the obtaining the quantization scale comprises adjusting the maximum value and the minimum value of the parameter of the neural network model to satisfy
$$b - a = C \cdot {2}^{\hat{k}} , C = \frac{{2}^{n} - 1}{{2}^{n}} ,$$
where b is the maximum value, a is the minimum value, n is a bit number of quantization, and \hat{k} is a random integer.

3. The control method of claim 2, wherein the obtaining the quantization scale further comprises, based on the electronic device performing symmetric quantization, adjusting the maximum value and the minimum value of the parameter of the neural network model to satisfy \tilde{b}=2^{nearest_int(log}^{₂}^{b/C)}, ã=−2^{nearest_int(log}^{₂}^{b/C)}, where \tilde{b} is a power of two adjacent to b, and ã is a power of two adjacent to a.

4. The control method of claim 3, wherein, based on the electronic device performing symmetric quantization, the quantization scale s is obtained based on
$$s = \frac{{2}^{n - 1}}{{2}^{nearest \_ int ( {log}_{2} b / C )}} .$$

5. The control method of claim 2, wherein the obtaining the quantization scale comprises, based on the electronic device performing asymmetric quantization, adjusting the maximum value b and the minimum value a of the parameter of the neural network model to satisfy \tilde{d}=2^{nearest_int(log}^{₂}^{d)}, d=(b−a)/C where \tilde{d} is a power of two adjacent to d.

6. The control method of claim 5, wherein, based on the electronic device performing asymmetric quantization, the quantization scale s is obtained based on
$$s = \frac{{2}^{n}}{{2}^{nearest \_ int ( {log}_{2} ( b - a ) / C )}} .$$

7. The control method of claim 1, wherein the obtaining the information about the parameter of the neural network model comprises:
obtaining information about a quantization option comprising information about bit numbers of quantization for each layer and information about whether quantization scales for each layer are a power of two, and
wherein the quantizing comprises quantizing the parameter of the neural network model based on the information about the quantization option.

8. The control method of claim 1, wherein the parameter of the neural network model comprises a weight and an activation, and
wherein the quantizing comprises:
performing quantization for each channel based on the weight; and
performing quantization for each layer based on the activation.

9. An electronic device comprising:
memory storing instructions; and
at least one processor,
wherein the instructions, when executed by the at least one processor, cause the electronic device to:
obtain information about a parameter of a neural network model,
identify a maximum value and a minimum value of the parameter of the neural network model based on the obtained information about the parameter of the neural network model,
obtain a quantization scale in the form of a power of two by adjusting the maximum value and the minimum value of the parameter of the neural network model, and
quantize the parameter of the neural network model based on the quantization scale in the form of a power of two.

10. The electronic device of claim 9, wherein the instructions, when executed by the at least one processor, further cause the electronic device to adjust the maximum value and the minimum value of the parameter of the neural network model to satisfy b−a=C·2^{\hat{k}},
$$C = \frac{{2}^{n} - 1}{{2}^{n}} ,$$
where b is the maximum value, a is the minimum value, n is a bit number of quantization, and \hat{k} is a random integer.

11. The electronic device of claim 10, wherein the instructions, when executed by the at least one processor, further cause the electronic device to, based on the electronic device performing symmetric quantization, adjust the maximum value and the minimum value of the parameter of the neural network model to satisfy \tilde{b}=2^{nearest_int(log}^{₂}^{b/C)}, ã=−2^{nearest_int(log}^{₂}^{b/C)}, where \tilde{b} is a power of two adjacent to b, and ã is a power of two adjacent to a.

12. The electronic device of claim 11, wherein, based on the electronic device performing symmetric quantization, the quantization scale s is obtained based on
$$s = \frac{{2}^{n - 1}}{{2}^{nearest \_ int ( {log}_{2} b / C )}} .$$

13. The electronic device of claim 10, wherein the instructions, when executed by the at least one processor, further cause the electronic device to, based on the electronic device performing asymmetric quantization, adjust the maximum value b and the minimum value a of the parameter of the neural network model to satisfy \tilde{d}=2^{nearest_int(log}^{₂}^{d)}, d=(b−a)/C, where \tilde{d} is a power of two adjacent to d.

14. The electronic device of claim 13, wherein, based on the electronic device performing asymmetric quantization, the quantization scale s is obtained based on
$$s = \frac{{2}^{n}}{{2}^{nearest \_ int ( {log}_{2} ( b - a ) / C )}} .$$

15. The electronic device of claim 9, wherein the instructions, when executed by the at least one processor, further cause the electronic device to:
obtain information about a quantization option comprising information about bit numbers of quantization for each layer and information about whether quantization scales for each layer are a power of two, and
quantize the parameter of the neural network model based on the information about the quantization option.
